(19) United States
(12) Patent Application Publication
(10) Pub. No.: US 2015/0180715 A1
(43) Pub. Date: Jun. 25, 2015

(54) METHOD OF CONSTRUCTING LOGICAL NETWORK AND NETWORK SYSTEM

(71) Applicant: HITACHI, LTD., Tokyo (JP)

(72) Inventors: Yoji OZAWA, Tokyo (JP); Jyunji KINOSHITA, Tokyo (JP); Osamu TAKADA, Tokyo (JP)

(21) Appl. No.: 14/575,124

(22) Filed: Dec. 18, 2014

(30) Foreign Application Priority Data
Dec. 25, 2013 (JP) 2013-266316

(51) Int. Cl. H04L 12/24

(52) U.S. Cl. CPC H04L 41/0816

(57) ABSTRACT

There is provided a method of constructing a logical network which determines a network apparatus of a deployment location and a middlebox apparatus when the logical network is constructed on a physical network to which the network apparatus, the middlebox apparatus, and a physical server are coupled, in which an abstract configuration of the logical network and logical network information including a performance requirement with respect to a configuration element are received, and the network apparatus which become a deployment location of the logical network and the middlebox apparatus are determined according to the abstract configuration of the logical network and the performance requirement.

### CROSS-REFERENCE TO RELATED APPLICATION

This application claims the priority of Japanese Patent Application No. 2013-266316 filed on Dec. 25, 2013, the entire contents of which are incorporated herein by reference in its entirety.

### BACKGROUND

The subject matter to be disclosed relates to construction of a logical network.

In recent years, in order to reduce cost of owning IT resources and a cope with a severely fluctuating business environment, a cloud service is expected to be used in a system for which performance and reliability are needed, for example, a backbone system. In the system for which performance and reliability are needed, it is necessary to guarantee a performance requirement in regard to a network similarly to a virtual machine or the like.

In most cloud management systems in the related art, a virtual network coupling virtual machines to each other is constructed in an overlay type by a tunnel between virtual switches accommodating the virtual machines. In the overlay type, a virtual network can be constructed without the need for understanding or setting the configuration of a physical network through the tunnel.

However, determination of a physical device in which the virtual network considering performance for a device constituting the physical network and the capacity of a resource or the like is deployed, and setting for guaranteeing the performance of the determined physical device are necessary for guaranteeing the performance of the virtual network.

Further, in networks for tenant administrators of each cloud, a virtual network coupling the virtual machines to each other, and a middlebox apparatus (hereinafter, also referred to as MB) which is coupled to the virtual network and controls a packet such as a firewall (hereinafter, referred to as FW) or a load balancer (hereinafter, referred to as LB) are necessary, and the performance guarantee is necessary with respect to the location of the MB and the MB itself. In IETF RFC 3234, a middlebox is defined as a device performing a process beyond the normal performance of an IP router or a “function” virtually incorporated in a device. Further, here, networks for each of the tenant administrators including the virtual network and the MB are referred to as “logical networks.”

In a cloud management system in the related art, since the physical network and the MB are not managed, construction of the logical network guaranteeing the performance requirement is difficult.

In the related art, as a technique for constructing a virtual network in consideration of the physical configuration, there is a method of designing a virtual network which automates the allocation of the virtual network onto the physical network and avoids allocation which may cause an inefficient state on the physical network (JP-A-2012-169874, paragraphs [0012] to [0015]).

Problems in the related art are as follows.

In the related art, allocation of the virtual network onto the physical network is determined by considering the number of hops and delay of the physical network. However, there are various requirements such as a guaranteed bandwidth and availability in addition to the delay of the network in the performance requirements with respect to the virtual network. Further, in addition to the virtual network coupling the virtual machines to each other, the FW or the MB such as the LB is included in the logical network, and there are also performance requirements such as a throughput of the MB and the like. In the related art, a deployment location on the physical network cannot be determined in correspondence with these various performance requirements. In addition, the number of candidates of deployment locations to the physical network is increased so that the amount of calculation becomes larger as the kinds of performance requirements which are dealt with are increased in general. Further, the kinds or the values of the performance requirements intended to be specified vary depending on a tenant administrator, and it is necessary to easily specify the performance requirements.

In the related art, there is a problem in that the performance requirements of the logical network are difficult to specify easily and the deployment location of the logical network is difficult to determine in correspondence with the various performance requirements described above.

### SUMMARY

For solving the above-described problem, a method of constructing a logical network in which a logical network guaranteeing a performance requirement can be easily constructed even when a physical configuration is not considered and a management server used therefor are disclosed in the present specification.

Specifically, there is provided a method of constructing a logical network which determines a network apparatus of a deployment location and a middlebox apparatus when the logical network is constructed on a physical network to which the network apparatus, the middlebox apparatus, and a physical server are coupled, in which an abstract configuration of the logical network and logical network information including a performance requirement with respect to a configuration element are received, and the network apparatus which becomes a deployment location of the logical network and the middlebox apparatus are determined according to the abstract configuration of the logical network and the performance requirement; and there is provided a management server used therefor.

According to an aspect of the invention, there is provided a method of constructing a logical network in which a management server is coupled to a physical network to which a plurality of physical servers or a plurality of physical servers and a physical middlebox are respectively coupled through a physical network apparatus, the logical network is a network to which a virtual machine, and any one or both of a physical middlebox and a virtual middlebox are coupled through any one or both of the physical network apparatus and a virtual network apparatus, the virtual middlebox is realized on any one or both of the physical server and a physical middlebox apparatus, and the method includes, causing the management server to receive configuration information of the logical network and a logical network reservation request including a performance requirement with respect to a constituent element of the logical network, to determine the plurality of physical servers, or the plurality of physical servers and the physical middlebox, and the physical network apparatus which are deployment locations of the logical network, and setting contents therefor based on the received configuration information and the received performance requirement of the logical network, and to determine the setting contents for the plurality of physical servers, or the plurality of physical servers and the physical middlebox, and the physical network apparatus which are all determined.

Further, in the method of constructing a logical network, the configuration information of the logical network includes information related to one or more logical switches which are constituent elements, and one or more logical middlebox apparatuses, the logical switch is configured using a plurality of the physical network apparatuses, and includes setting items including a segment representing a broadcast domain in the logical switch, an abstracted physical port in association with the segment, and an abstracted logical port to which the logical middlebox apparatus is coupled, and the performance requirement with respect to the logical network is specified by setting at least any one of performance requirement specification objects including the logical switch, the segment in the logical switch, the abstracted physical port in association with the segment, the logical middlebox apparatus, and the abstracted logical port as an object.

According to the above-described aspect, when the logical network required by a cloud administrator is constructed on the physical network, an infrastructure administrator can determine an apparatus on the physical network, which constructs the logical network satisfying the performance requirement specified by the cloud administrator and determine the setting contents for the apparatus.

The cloud administrator can specify a logical network specification using various performance requirements such as delay, a guaranteed bandwidth, and a throughput with respect to a middlebox, which can be understood by the cloud administrator, without considering the configuration of the physical network, the performance of a physical apparatus, resource capacity, and the like.

According to the disclosure, it is possible to construct a logical network satisfying a performance requirement even when a physical configuration is not considered.

Problems, configurations, and effects which are not described above will become obvious from the description of the embodiments below.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating the configuration of a network system according to an embodiment.

FIG. 2 is an explanatory diagram illustrating the configuration of a logical NW which is input information according to the embodiment.

FIG. 3 is a block diagram illustrating the configuration of a physical NW management server according to the embodiment.

FIG. 4 is an explanatory diagram illustrating the configuration of mapping information to a physical item candidate of a performance requirement according to the embodiment.

FIG. 5 is an explanatory diagram illustrating the configuration of physical device management information according to the embodiment.

FIG. 6 is an explanatory diagram illustrating the configuration of physical port information according to the embodiment.

FIG. 7 is an explanatory diagram illustrating the configuration of the physical coupling information according to the embodiment.

FIG. 8 is an explanatory diagram illustrating the configuration of physical MB information according to the embodiment.

FIG. 9 is an explanatory diagram illustrating the configuration of physical server information for a virtual MB according to the embodiment.

FIG. 10 is an explanatory diagram illustrating the configuration of sub physical NW information according to the embodiment.

FIG. 11 is an explanatory diagram illustrating the configuration of logical NW information according to the embodiment.

FIG. 12 is an explanatory diagram illustrating the configuration of user information according to the embodiment.

FIG. 13A is a sequence diagram illustrating the flow of a process of reserving the logical NW and creating a tenant according to the embodiment.

FIG. 13B is a sequence diagram illustrating the flow of a process of constructing the logical NW according to the embodiment.

FIG. 14A is an explanatory diagram illustrating the configuration of a message which is transmitted to or received from apparatuses at the time of performing the process of reserving the logical NW and creating the tenant according to the embodiment.

FIG. 14B is an explanatory diagram illustrating the configuration of a message which is transmitted to or received from apparatuses at the time of performing the process of constructing the logical NW according to the embodiment.

FIG. 15 is a flowchart illustrating a process of calculating the MB and a deployment location of an abstracted physical port according to the embodiment.

FIG. 16 is a diagram illustrating procedures of the process of calculating the MB and the deployment location of the abstracted physical port according to the embodiment.

### DETAILED DESCRIPTION OF THE EMBODIMENTS

Hereinafter, the embodiments will be described with reference to the accompanying drawings.

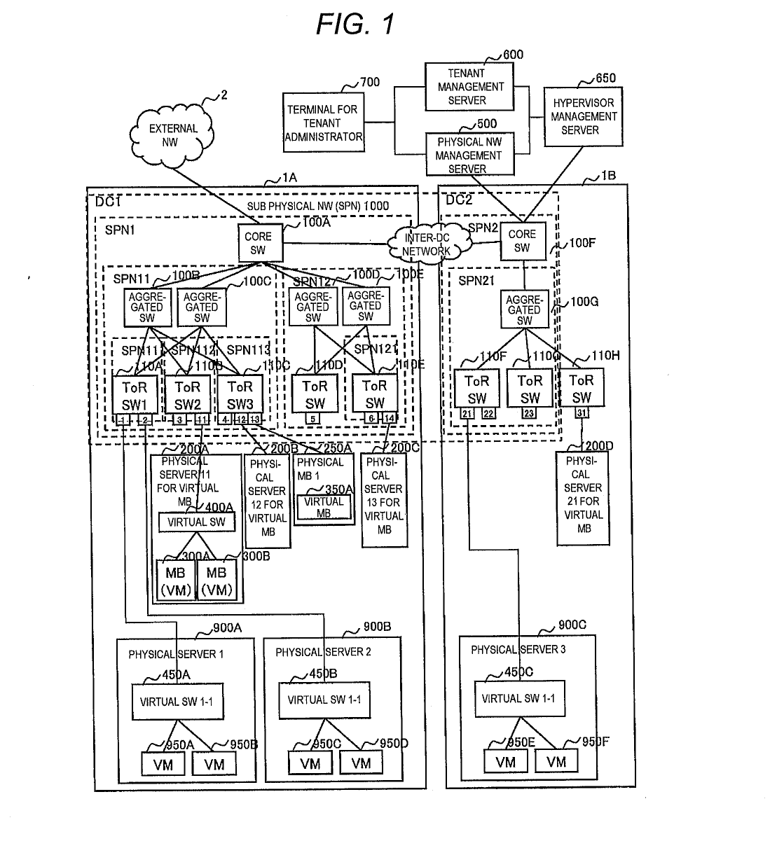

FIG. 1 is a block diagram illustrating the configuration of a network system according to the present embodiment.

The network system of the present embodiment is configured by including a plurality of physical network apparatuses (hereinafter, also referred to as a Network (NW) apparatus) transferring a packet, a plurality of computers, and a management computer. Specifically, as illustrated in FIG. 1, the network system is configured by including core switches (hereinafter, a switch is also referred to as an SW) (100A and 100F), Aggregated SWs (100B, 100C, 100D, 100E, and 100G), ToR SWs (110A to 110H), physical servers for virtual MB (200A to 200D), a physical MB (250A), physical servers (900A to 900C), a physical NW management server 500, a tenant management server 600, a tenant operator terminal 700, and a hypervisor management server. The physical NW management server 500 and the tenant management server 600 may be one server and are collectively referred to as a virtual machine management server.

Hereinafter, the core SW (100), the aggregated SW (100), and the ToR SW (110) are collectively referred to as an SW.

The physical server for virtual MB 200 creates a virtual machine (Virtual Machine: hereinafter, noted as a VM) and operates the virtual MB on the VM. In regard to the physical MB 250A, there are a case in which one tenant uses one apparatus and a case in which the physical MB is logically partitioned in plural, a plurality of middlebox functions are constructed thereon, and each of the middlebox functions is used by a tenant. The middlebox function which is operated when the VM or the physical MB is logically partitioned and can be handled as a virtual apparatus, and accordingly, the function is referred to as a virtual middlebox apparatus (virtual MB). The virtual MBs are, for example, an FW apparatus, an LB apparatus, and a VPN apparatus. In addition, the middlebox function or the middlebox apparatus controls discarding of the packet or conversion of a header.

The physical server generates the VM and operates a server with a tenant. The physical server is not an object to be managed by the physical NW management server.

The physical NW management server manages the SW, the physical server for virtual MB, the physical MB, and the Inter-DC NW. The deployment location of the MB, the abstracted physical port provided to the NW for a tenant, and the SW coupling the MB and the abstracted physical port are calculated and setting for guaranteeing performance is performed according to the performance requirement from the cloud administrator.

The tenant management server constructs a tenant. Particularly, the NW for a tenant creates a tunnel between the virtual SWs on the physical server. The virtual network for a tenant whose performance is guaranteed can be constructed by constructing the VM on the physical server coupled to the abstracted physical port provided by the physical NW management server. In addition, in order to couple the VM with the MB, it is necessary to set termination of the tunnel on the virtual SW accommodating the MB or the Tor SW.

The tenant operator terminal 700 is a terminal providing a user interface for operating the physical NW management server and the tenant management server. The terminal for an administrator is used by the cloud administrator or the tenant administrator. The cloud administrator acquires the logical NW, couples the physical server with the logical NW, and provides the cloud service using the physical NW management server 500. The tenant administrator creates a tenant on the cloud service provided by the cloud administrator using the tenant management server. Further, even when the logical NW is used for each tenant, the logical NW may be used by a plurality of tenants by being prepared for each of the cloud service. Further, the logical NW can be used for the management network for each cloud service. In this case, the tenant administrator uses the terminal when the logical NW is used for each tenant and the cloud administrator uses the terminal when the logical NW is used for the management network.

The hypervisor management server constructs the physical server for virtual MB, and the VM and the virtual SW on the physical server.

The sub physical network (NW) sub physical network (SPN) is obtained by grouping at least one SW. In the sub physical NW, when a multi-path configuration such as fabric or a redundant configuration is employed and has a performance guideline such as a bandwidth or delay, a performance requirement such as availability related to the redundant configuration can be specified to the segment of the logical NW or the configuration can be set as a deployment location candidate of the segment of the logical NW. Further, the SW may not belong to the sub physical NW. For example, the ToR SW110H does not belong to the sub physical NW in FIG. 1.

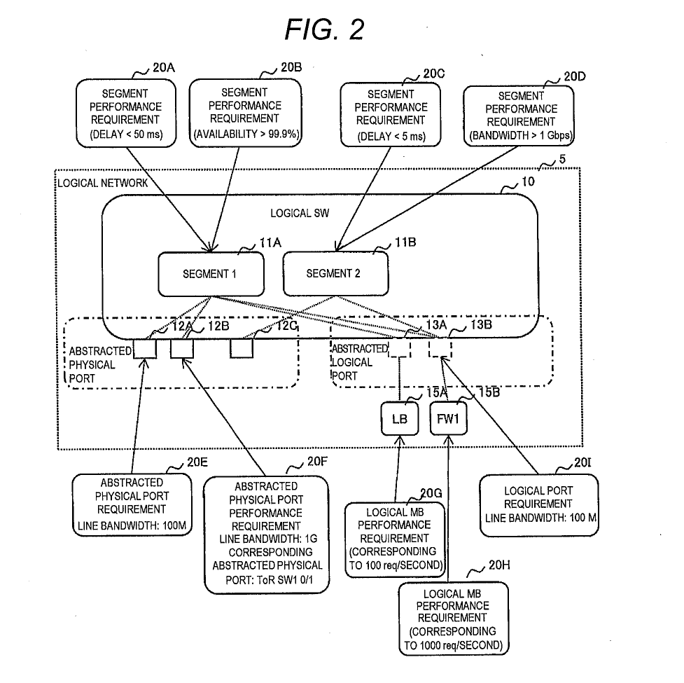

FIG. 2 is a diagram illustrating input information to the physical NW management server of the present embodiment, configuration information of the logical NW, and the performance requirement.

The logical NW5 includes the logical SW10 and the MB15. The logical SW and the MB may be plural and the plurality of logical SWs are coupled with one another through the MB. The logical SW10 includes an abstracted physical port, an abstracted logical port, and a segment which are abstracted constituent elements. Further, the segment, the abstracted physical port, and the abstracted logical port are associated with one another. The cloud administrator specifies the performance requirement with respect to the segment, the abstracted physical port, the abstracted logical port, and the MB which are the constituent elements of the logical NW. Since these constituent elements are abstracted, the physical configuration does not have to be considered so that the cloud administrator can easily specify the performance requirement. The performance requirement includes the types of requirements such as the bandwidth, delay, and availability, and the value of performance.

The logical SW 10 may be configured to be across a plurality of DCs in correspondence with a plurality of SWs in the physical network. The logical SW includes the abstracted physical port and the abstracted logical port. The abstracted physical port corresponds to the physical port of SW. The cloud administrator couples the physical port to the physical server and deploys the VM, on the physical server. At the time of the input, only the number of the abstracted physical ports may be specified or the correspondence to the physical port may be specified. In the case where only the number thereof is specified, the physical NW management server calculates the physical port positioned in a location corresponding to the abstracted physical port.

The abstracted logical port is a port for coupling the MB and does not present which port of the physical network is to be coupled with the MB to the cloud administrator. This is because the physical MB is an object to be managed by the infrastructure administrator, and thus the cloud administrator does not need to grasp where to be coupled physically. The cloud administrator can specify the performance requirement with respect to the abstracted logical port.

Further, the abstracted logical port may be coupled with an external network. The external network is the Internet or a virtual private network (VPN).

The segment indicates a broadcast domain. The segment is coupled with the abstracted physical port and the abstracted logical port.

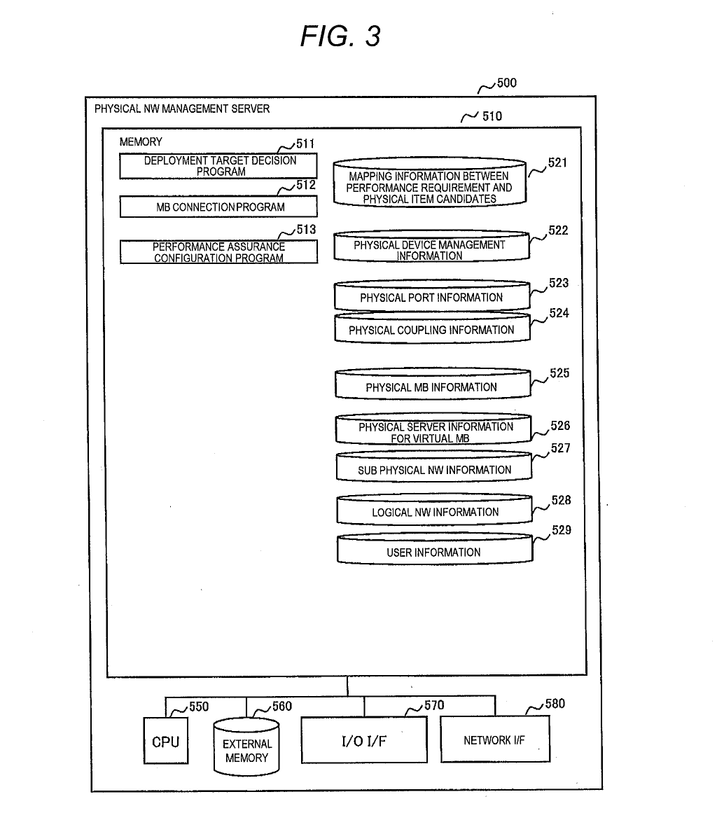

FIG. 3 is a block diagram describing the configuration of the physical NW management server 500 according to the present embodiment.

The physical NW management server 500 includes a processor 550, a memory 510, an internal storage device 560, an I/O interface (I/F) 570, and a network interface (I/F) 580.

The management server 500 transmits or receives information through another devices coupled with the network, for example, the SW 100 and the like, and the network I/F 580.

The processor 550 executes a program to be held by the memory 510. The memory 510 holds the program executed by the processor 550 and information necessary for executing the program.

Specifically, the memory 510 holds a deployment target decision program 511, an MB connection program 512, and a performance assurance configuration program 513. Further, the memory 510 holds mapping information between performance requirement and physical item candidates 521 satisfying the object for specifying the performance requirement (hereinafter, simply noted as the mapping information), physical device management information 522, physical port information 523, physical coupling information 524, physical MB information 525, physical server information 526 for a virtual MB, sub physical NW information 527, logical NW information 528, and user information 529.

The processor 550 is operated as a function unit having a predetermined function by being operated according to the program held by the memory 510.

In the description below, in a case where the description is made by using the function unit as the subject, this means that the processor 550 is operated according to the program for realizing the function unit.

In addition, each program may be held by a non-transitory storage medium such as the internal storage device 560. In this case, the processor 550 reads the program from the internal storage device 560 and loads the read program in the memory 510, and executes the loaded program.

Further, information such as a table held by the memory 510 can be held in storage devices such as the internal storage device 560, a non-volatile semiconductor memory, a hard disk drive, and a Solid State Drive (SSD), or computer-readable non-transitory data storage media such as an IC card, an SD card, and a DVD.

Hereinafter, the programs and information held by the memory 510 will be described.

The deployment target decision program 511 realizes a deployment target decision unit that calculates a path coupling the MB with the deployment location of the abstracted physical port and coupling the MB with the abstracted physical port based on configuration information of the logical NW from the cloud administrator and the performance requirement.

The MB connection program 512 sets a tunnel for a segment on the virtual SW on the physical server for the virtual MB or on the SW accommodating the physical MB for connecting the virtual MB or the physical MB managed by a physical NW management system to the segment between the VMs created by the tenant management server 600.

The performance assurance configuration program 513 realizes a performance assurance configuration unit that performs the setting for the performance guarantee such as bandwidth control and priority transfer control on the SW for guaranteeing the specified performance.

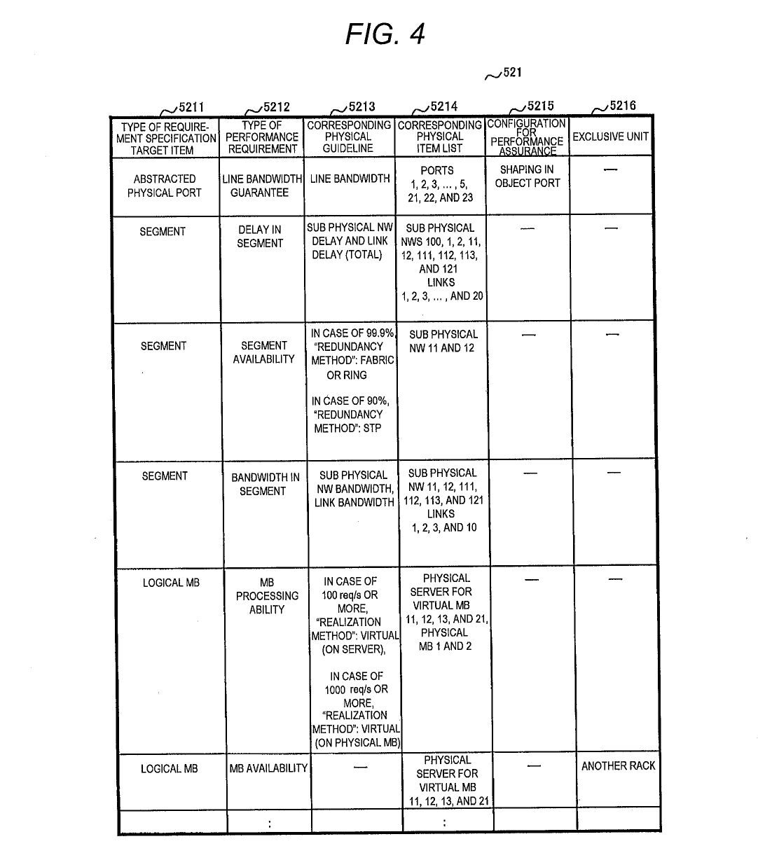

The mapping information 521 holds information indicating the type of the performance requirement, the corresponding physical item candidate, the value of performance requirement, and the attribute of the corresponding physical item for each object for specifying the performance requirement. The details of the mapping information 521 will be described with reference to FIG. 4.

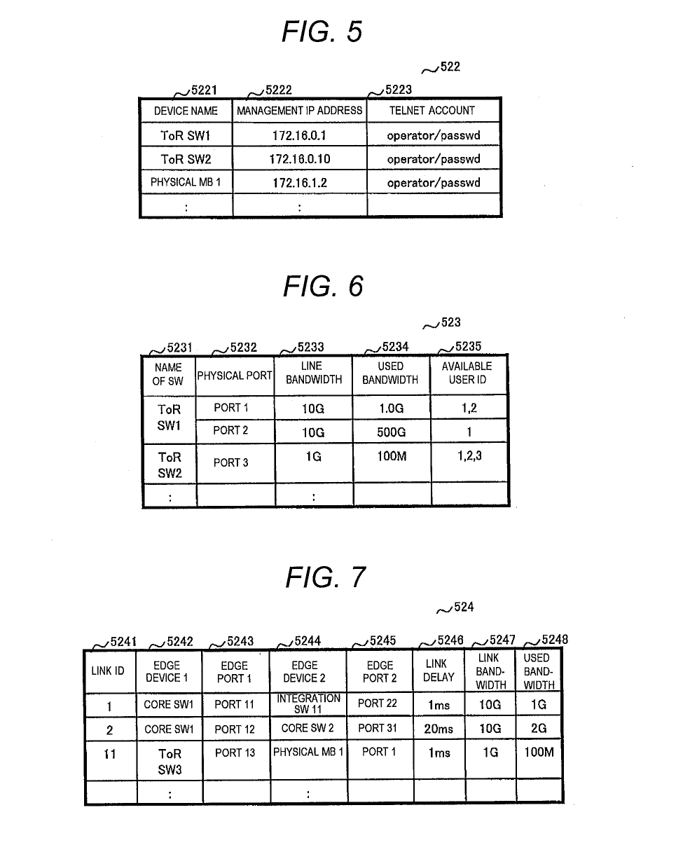

The physical device management information 522 holds information indicating management IP addresses or the like for setting the SW. The details of the physical device management information 522 will be described with reference to FIG. 5.

The physical port information 523 is a physical port information managing unit that holds information indicating the abstracted physical port of the SW, and the line bandwidth or a used bandwidth of the abstracted physical port. The details of the physical port information 523 will be described with reference to FIG. 6.

The physical coupling information 524 is a link information managing unit between network apparatuses holding information indicating attributes such as a link coupling physical apparatuses and delay or a bandwidth of the link. The details of the physical coupling information 524 will be described with reference to FIG. 7.

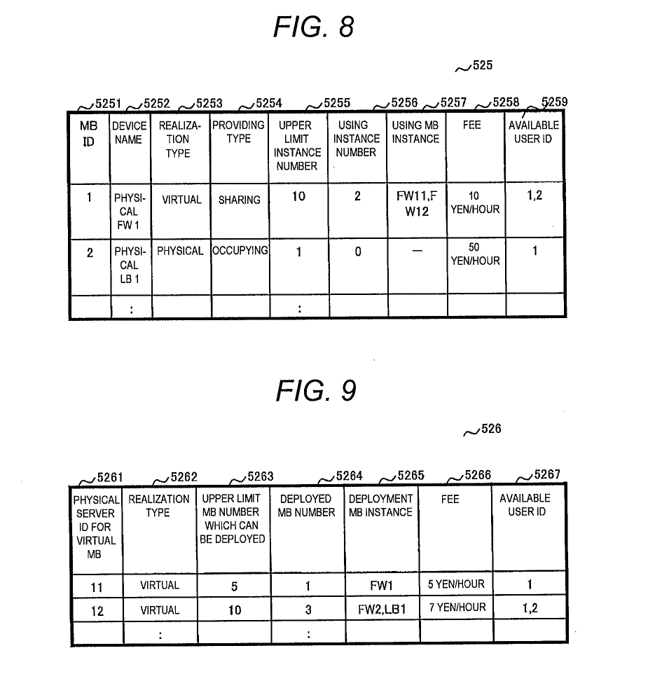

The physical MB information 525 holds information indicating the number of virtual MBs which can be provided by logically partitioning the physical MB and the use state. The details of the physical MB information 525 will be described with reference to FIG. 8.

The physical server information 526 for a virtual MB holds information indicating the number of the virtual MBs which can be provided by the physical server for virtual MB and the use state. The details of the physical server information 526 for a virtual MB will be described with reference to FIG. 9. In addition, the physical MB information 525 and the physical server information 526 for a virtual MB are collectively referred to as a middlebox apparatus information managing unit.

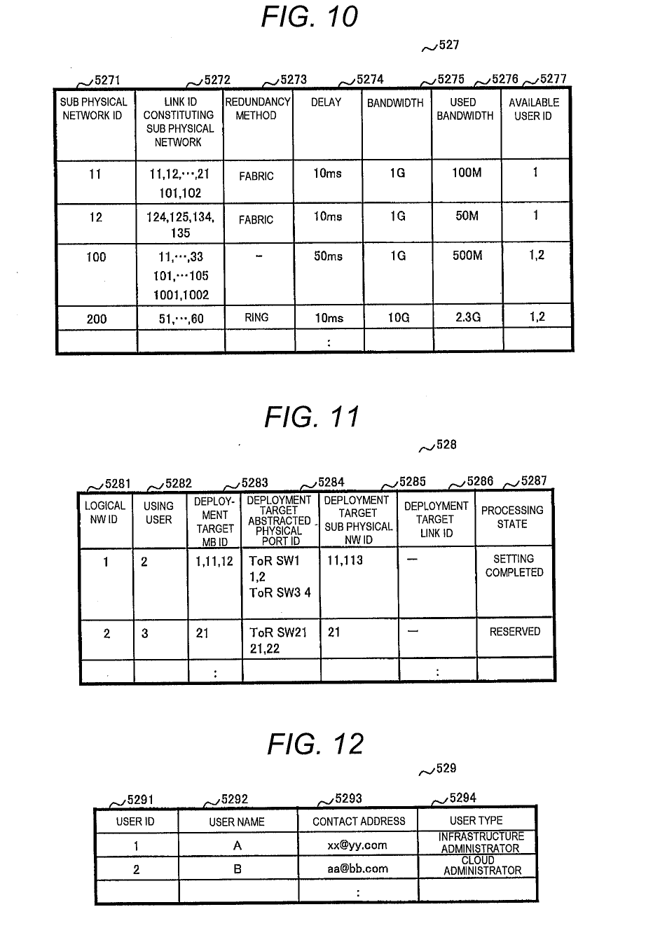

The sub physical NW information 527 is a sub physical NW information managing unit which holds information indicating a redundancy method in the sub physical NW, delay, and the like. The details of the sub physical NW information 527 will be described with reference to FIG. 10.

The logical NW information 528 holds information indicating the MB in which the logical NW is deployed, the abstracted physical port, and the state of the process. The details of the logical NW information 528 will be described with reference to FIG. 11.

The user information 529 holds information indicating a contact address of the user. Since the user information whose element can be used is set in the physical MB information and the physical port information, the deployment location can be calculated from the physical MB allocated for each user and the abstracted physical port. In this manner, the physical items usable for each user can be controlled. The details of the user information 529 will be described with reference to FIG. 12.

FIG. 4 is an explanatory diagram illustrating an example of the configuration of the mapping information 521 according to the present embodiment. The respective items below are associated with one another to be managed as the mapping information 521.

A type of a requirement specification target item 5211 is a type of an object for specifying the performance requirement in the virtual NW information which is the input information. As the values of the items, an “abstracted physical port,” an “abstracted logical port,” a “segment,” and “logical MB” can be exemplified.

A type 5212 of the performance requirement is a type of the performance requirement, and line bandwidth guarantee, delay, or availability is included therein. In addition, the values of the items are requirements with respect to the constituent element of the virtual NW and a cloud administrator that does not understand the physical configuration can perform specification.

A corresponding physical guideline 5213 is a guideline of the physical item to be used when the deployment location is determined.

A corresponding physical item list 5214 is a list of physical items which becomes the deployment location candidate of the logical NW constituent element specified by the type of the requirement specification target item 5211. The deployment location is determined from among the items of the list.

configuration 5215 for the performance guarantee is the setting content necessary for guaranteeing the required performance requirement. For example, in a case of guaranteeing the line bandwidth, shaping for an object port is set. “-” means that there is no content to be set.

An exclusive unit 5216 is information for not deploying the element of the virtual NW in which the same requirement is specified in the same virtual NW in the same range. For example, in a case of “another rack”, the logical MB in which the performance requirement is specified is deployed to the physical device of another rack. In this manner, the deployment location of a redundant device can be controlled by considering an expected failure range.

An individual algorithm is necessary for each performance requirement in a deployment location determining technique in the related art, but since the mapping information 521 does not depend on the types of the performance requirement, it is possible to easily correspond to a new requirement and to correspond to various performance requirements by adding items to the information.

FIG. 5 is an explanatory diagram illustrating an example of the physical device management information 522 according to the present embodiment. However, the physical device management information 522 is management information for controlling an NW machine. For example, when the ToR SW110 is set for the bandwidth guarantee, a setting object device can be accessed using the information. A device name 5221 is a name of the NW device constituting the network system. A management IP address 5222 is an IP address used when an object device is set. Telnet account 5223 is account information for coupling by Telnet when the object device is set.

FIG. 6 illustrates an example of the attribute information and the network resource information of the physical port of the physical network apparatus, which is managed by the physical port information 523 according to the present embodiment. An SW name 5231 is a name of an SW having a physical port. A physical port 5232 is a name of an object physical port. A line bandwidth 5233 is line bandwidth information of the physical port and a bandwidth up to the value of the item can be used. A used bandwidth 5234 is a total amount of the bandwidth being used and allocated to the logical NW at the present time. Therefore, the used bandwidth is a bandwidth for which the line bandwidth 5233 and the used bandwidth 5234 can be used. Further, the actual traffic amount may be acquired from an actual device to be set as a value of the item. An available user ID 5235 is a user ID which can use the physical port. For example, in a case where the ID of a user that requires the logical NW is 2, ports which can be used as candidates of the deployment locations of the abstracted physical port are a port 1 and a port 3, but a port 2 is not used.

FIG. 7 illustrates an example of attribute information and network resource information of the link between physical network apparatuses which are managed by the physical coupling information 524 of the present embodiment. The information includes the links not only in the DC but also inter-DC. A link ID 5241 is information for uniquely identifying the links between apparatuses. An edge device 1 5242 is a device having a port with one end point of the link. An edge port 1 5243 is a port with one end point of the link. An edge device 2 5244 is a device having a port with an end point facing the link. An edge port 2 5245 is a port having an endpoint facing the link. Link delay 5246 is a transfer delay of the link. A link bandwidth 5247 is a bandwidth of the link. A used bandwidth 5248 is a total amount of bandwidths being used, which is allocated to the logical NW at the present time. Further, the actual traffic amount may be acquired from an actual device to be set as a value of the item.

FIG. 8 is an explanatory diagram illustrating an example of the physical MB information 525 according to the present embodiment. An MB ID 5251 is information for uniquely identifying the physical MB. A device name 5252 is a name of the physical MB. A realization type 5253 is a realization type of the MB, and the value thereof is “physical” or “virtual.” By the presence of the item, objects of the deployment location can be narrowed down by a common process using the corresponding physical guideline 5213 in FIG. 4. A providing type 5254 is a method of utilization by the logical NW of the physical MB. Specifically, there are “sharing” and “occupying,” and the physical MB is partitioned into a plurality of virtual MBs (virtual MB) and the partitioned virtual MB is used for the logical NW in a case of “sharing.” In contrast, in a case of “occupying,” the physical MB is used by the logical NW as it is. An upper limit instance number 5255 is the maximum number of the virtual MB in a case where the providing type is “sharing.” In addition, the upper limit instance number 5255 is one piece of the resource information. A using instance number 5256 is a number of the virtual MB being used, which is created at the present time. Further, the using instance number 5256 is one piece of resource utilization situation information. A using MB instance 5257 is a name of the virtual MB being created and used. A fee 5258 is a fee for using the physical MB and the virtual MB. An available user ID 5259 is a user ID for which the physical MB can be used.

FIG. 9 is an explanatory diagram illustrating an example of the physical server information 526 for the virtual MB according to the present embodiment. A physical server ID 5261 for the virtual MB is information for uniquely identifying the physical server for the virtual MB. A realization type 5263 is a method of realizing the MB and “virtual” is fixed. By the presence of the item, objects of the deployment location can be narrowed down by a common process using a corresponding physical guideline 5213 in FIG. 4. An upper limit MB number 5263 which can be deployed is the number of the upper limit of the virtual MB which can be deployed in the physical server for the virtual MB. A deployed MB number 5264 is the number of the deployed virtual MB at the present time. A deployment MB instance 5265 is a name of the deployed virtual MB at the present time. A fee 5266 is a fee for utilizing the virtual MB. An available user ID 5267 is a user ID which can utilize the physical server for the virtual MB.

FIG. 10 is an explanatory diagram illustrating an example of sub physical NW information 527. The sub physical NW ID 5271 is information for uniquely identifying the sub physical NW. A link ID 5272 constituting the sub physical NW is a list of link ID constituting the sub physical NW. A redundancy method 5273 is a redundancy method configured in the sub physical NW. Delay 5274 is transfer delay in the sub physical NW. A bandwidth 5275 is a bandwidth in the sub physical NW and can use the bandwidth up to the value of the item. The bandwidth is information included in network resource information. A used bandwidth 5276 is a total amount of bandwidth being used, which is allocated to the logical NW at the present time. Further, the actual traffic amount may be acquired from an actual device to be set as a value of the item. An available user ID 5277 is a user ID which can use the sub physical NW.

FIG. 11 is an explanatory diagram illustrating an example of logical NW information 528 according to the present embodiment. A logical NW ID 5281 is information for uniquely identifying the logical NW. A using user 5282 is a user using the logical NW. Further, a user creating the logical NW is different from a user using the logical NW in some cases. For example, there may be a case in which a user in an upper level like an infrastructure administrator may create the logical NW for a user in a lower level such as the cloud administrator. A deployment target MB ID 5283 is an ID list of the MB in which the logical NW is deployed. A deployment location abstracted physical port ID 5284 is an ID list of the physical port in which the logical NW is deployed. A deployment location sub physical NW ID 5285 is an ID list of the sub physical NW in which the logical NW is deployed. A deployment location link ID 5286 is an ID list of the link in which the logical NW is deployed.

A processing state 5287 is a processing state of the logical NW and a “reserved” state is a state in which a deployment location is determined and a resource of the deployment location is reserved and setting for the performance guarantee or setting for coupling the MB with the segment has not been performed. A “set” state is a state in which setting for the performance guarantee or setting for coupling the MB to the segment is completed.

FIG. 12 is an explanatory diagram illustrating an example of the user information 529 according to the present embodiment. A user ID 5291 is information for uniquely identifying a user. A user name 5292 is a name of the user. A contact address 5293 is a contact address of the user and includes a mail address or a telephone number. A user type 5294 is information indicating the type of user, for example, an “infrastructure administrator,” a “cloud administrator,” or a “tenant administrator.” Depending on the type of the user, the range of a physical device and functions which can be used vary.

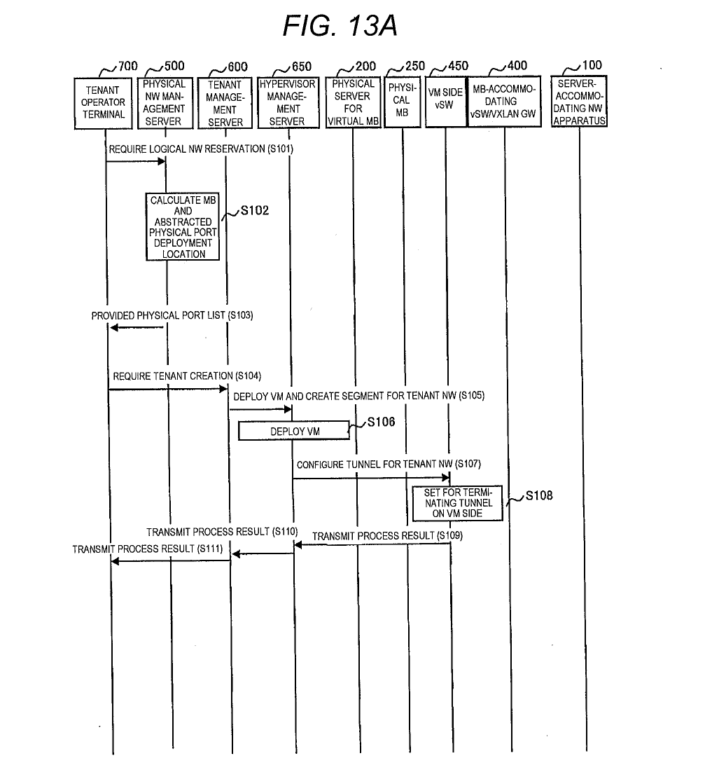

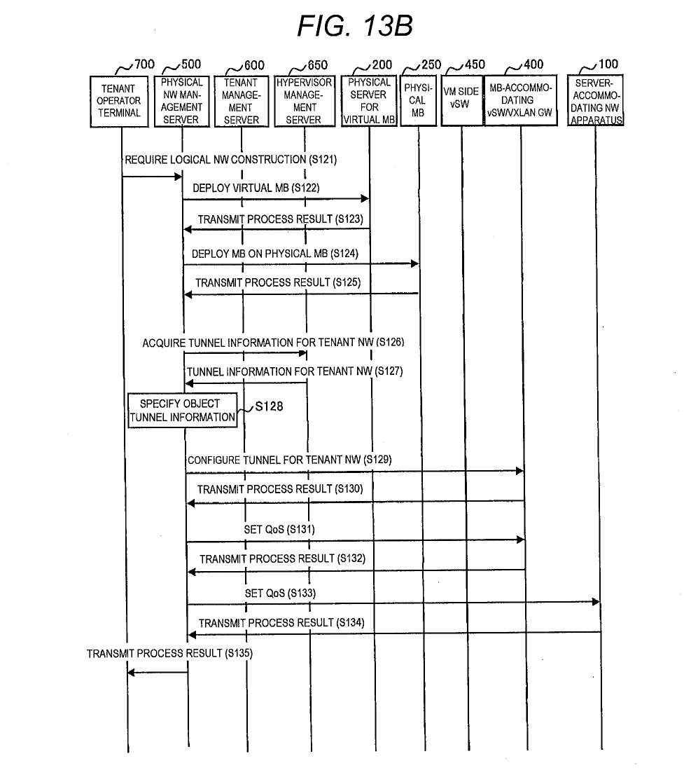

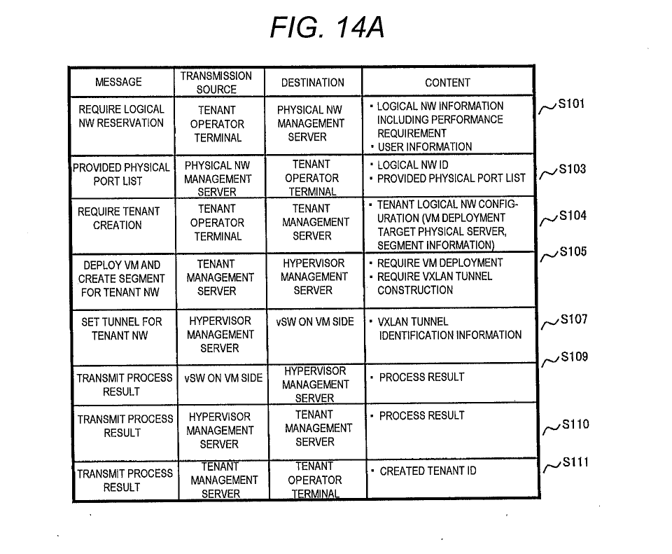

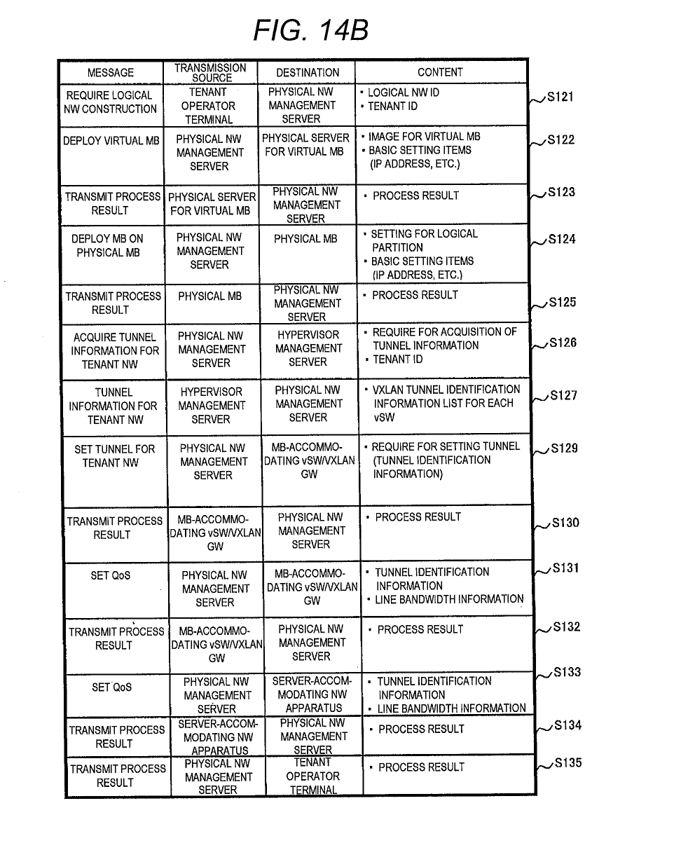

FIGS. 13A and 13B are sequence diagrams for describing the flows of a deployment target decision process of the logical NW in the network system according to the present embodiment, a setting process of the NW device for the performance guarantee, and an MB coupling process of coupling the MB with a segment. FIGS. 14A and 14B are explanatory diagrams illustrating an example of a message transmitted or received between devices at the time when the deployment target decision process of the logical NW according to the present embodiment, the setting process of the NW device for the performance guarantee, and an MB coupling process of coupling the MB with a segment are performed.

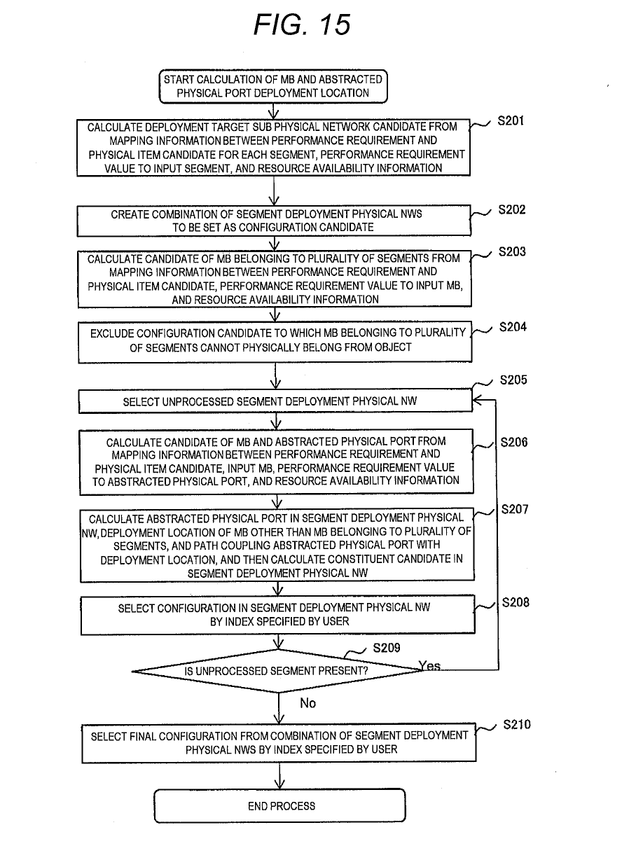

First, the tenant operator terminal 700 requires the physical NW management server 500 to perform logical NW reservation (S101). The configuration information of the logical NW, the logical NW information including performance requirements, and the user information related to the required user, which are illustrated in FIG. 2, are included in the requirement. After the physical NW management server 500 receives the requirement, the physical NW management server 500 performs a deployment location calculation process on the logical MB and the abstracted physical port according to the logical NW information included in the requirement (S102). The process will be described with reference to FIG. 15.

The physical NW management server 500 sets a processing state of the logical NW in which the logical NW information is created of FIG. 11 as “reserved” after the deployment locations of the logical MB and the abstracted physical port are determined, and transmits a physical port list provided to a terminal for an administrator (S103).

The tenant operator terminal 700 requires the tenant management server 600 to perform tenant creation (S104). In the requirement, the physical server for a VM coupled with the provided physical port transmitted in S103 is specified as a deployment location of the VM.

The tenant management server 600 requires the hypervisor management server 650 to perform segment creation for VM deploy and a tenant NW (S105). When the hypervisor management server 650 receives a requirement, the VM is deployed to the physical server for a VM (S106). Next, configuring of the tunnel for a tenant NW is performed on a vSW on the VM side (S107). The vSW accommodating the VM is set for terminating the tunnel corresponding to the segment (S108). As a technology for the tunnel for realizing the segment, VXLAN or GRE is exemplified, and logical partitioning may be performed using a VLAN.

The vSW on the VM side transmits process results to the hypervisor management server after setting for terminating the tunnel is completed (S109). The hypervisor management server 650 transmits process results of VM deploy and segment creation for a tenant NW to the tenant management server (S110). The tenant management server 600 transmits process results of the tenant creation to the tenant operator terminal 700 (S111).

The tenant operator terminal 700 requires the physical NW management server 500 to construct the logical NW (S121). The requirement contents include the reserved logical NW ID notified from the physical NW management server 500 and the created tenant ID notified from the tenant management server 600 in S103. Further, the processes subsequent to S122 may be continuously performed after the process of S110 is finished. In this case, information transmitted to the physical NW management server in S121 is transmitted when the process of S101 is performed.

The physical NW management server 500 deploys the virtual MB on the physical server for virtual MB 200 in the deployment location of the virtual MB which is determined at the time of reservation (S122). Specifically, a VM is created on the physical server for virtual MB 200 and a middlebox function is constructed.

The physical NW management server 500 deploys the logical MB on the physical MB 250 in the deployment location of the physical MB which is determined at the time of reservation (S124). In a case where the providing type 5254 illustrated in FIG. 8 is “sharing,” the physical MB is logically partitioned and the MB is deployed. In a case where the providing type 5254 is “occupying,” the physical MB is used as it is.

The physical NW management server 500 requires the hypervisor management server 650 to provide the tunnel information for a tenant NW (S126). The hypervisor management server 650 notifies the physical NW management server 500 of a list of the identification information related to a VXLAN tunnel for each vSW of the specified tenant (S127).

The physical NW management server 500 specifies the identification information of the VXLAN tunnel corresponding to the segment of the logical SW 10 (S128). Specifically, a set of the physical port included in the segment of the logical SW 10 and a set of the physical port coupled with the vSW to which the VXLAN is set are specified and then the VXLAN is set to a VXLAN corresponding to the segment. Further, the identification information (tunnel identification information) of the specified VXLAN is used for coupling of the MB with the segment and for QoS setting.

The physical NW management server 500 requires an MB-accommodating vSW or the VXLAN GW to configure termination of the tunnel such that the MB can be coupled with the segment (S129). Specifically, the vSW accommodating the MB coupled through the abstracted logical port for each segment or the VXLAN GW is set to terminate the tunnel of the identification information specified in S128, which corresponds to an object segment. The MB-accommodating vSW or the VXLAN GW notifies of the process results (S130).

The physical NW management server 500 performs setting of QoS for the performance guarantee on the physical port corresponding to the abstracted logical port with which the logical MB is coupled (S131). For example, the setting specified in the configuration 5215 for the performance assurance in FIG. 4 is performed.

The physical NW management server 500 performs setting of QoS for the performance guarantee on the physical port corresponding to the abstracted physical port (S133).

The physical NW management server 500 notifies the tenant operator terminal 700 of the process results (S135).

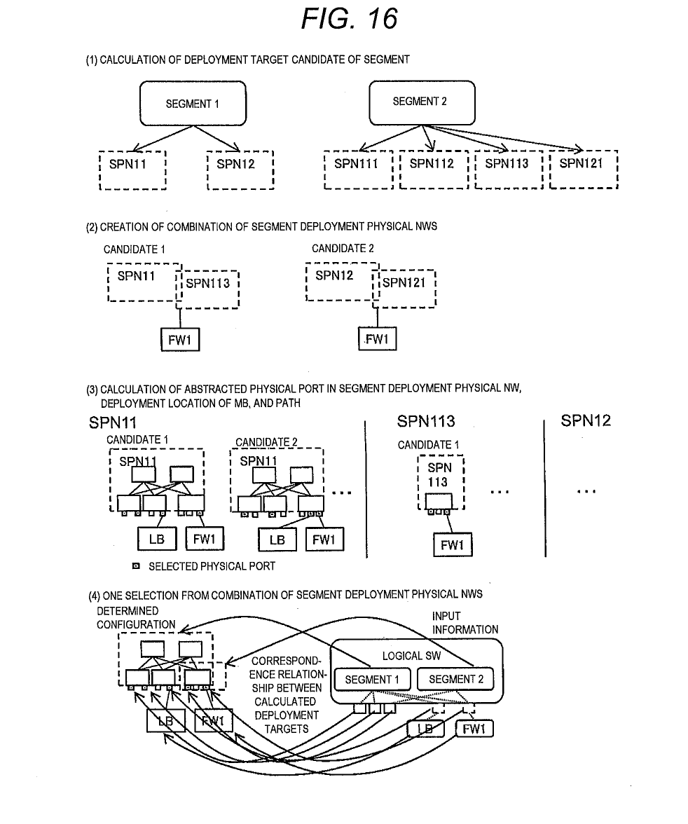

FIG. 15 is a flowchart describing the logical MB and an abstracted physical port deployment location calculation process of the present embodiment. The flowchart illustrates an example to be performed in S102 of FIG. 13A. Further, the image of procedures of the process is illustrated in FIG. 16.

The physical NW management server 500 calculates the deployment location sub physical NW candidate using mapping information of the performance requirement and the physical item candidate illustrated in FIG. 4 for each segment, the input performance requirement value to the segment illustrated in FIG. 2, and resource availability of the sub physical NW acquired from the resource utilization situation information (S201). For example, the performance requirement to the segment 1 in FIG. 2 is “delay<50 ms,” with reference to FIG. 4, the corresponding location candidates are sub physical NWs 1000, 1, 2, 11, 12, 111, 112, 113, and 121 from the second item, and the candidates are narrowed down to candidates (other than the sub physical NW 1000) whose delay is less than 50 ms with reference to the delay 5274 of FIG. 10 which is specified by the corresponding physical guideline 5213 among the candidates. Further, in regard to “availability>99.9%” which is the second performance requirement, with reference to FIG. 4 in the same manner, the corresponding location candidates are sub physical NWs 11 and 12 from the third item, and the sub physical NW 11 and 12 are set as the deployment location sub physical NW candidates with reference to the redundancy method 5273 of FIG. 10 which is specified by the corresponding physical guideline 5213. The candidates are narrowed down to the sub physical NW which can be used by the user ID as a requirement source with reference to the available user ID 5277 of FIG. 10.

Further, in a case where a bandwidth is specified as the segment performance requirement, the presence of an available bandwidth required based on the resource availability acquired from the resource utilization situation information is confirmed with reference to the bandwidth 5275 and the used bandwidth 5276 of FIG. 10.

The sub physical NW of the deployment location candidate is calculated for each segment illustrated in FIG. 16(1) using this process.

A combination of segment deployment physical NWs is created to be set as a configuration candidate (S202). Specifically, a combination of sub physical NWs of the deployment location candidate corresponding to the segment calculated in S201 is created.

Next, the deployment location candidates of the logical MB belonging to a plurality of segments are calculated from the resource availability acquired from the performance requirement illustrated in FIG. 4, mapping information of the physical item candidate, the performance requirement value to the input logical MB illustrated in FIG. 2, and the resource utilization situation information (S203). For example, since an FW 1 15B in FIG. 2 belongs to both of the segments 1 and 2, a deployment location candidate of the FW 1 15B is calculated. A performance requirement 20H to the FW1 15B is “corresponding to 1000 request/second,” and the candidates are narrowed down to the physical FW 1 (physical MB 1) of a candidate in which the realization type is “logic” with reference to the realization type 5253 of FIG. 8 which is specified by the corresponding physical guideline 5213 from the fifth item with reference to FIG. 4.

The configuration candidate calculated in S201, to which the logical MB belonging to the plurality of segments cannot physically belong is excluded from the object (S204). For example, since a combination of the sub physical NW 11 and 121 does not have a common physical port, and the sub physical NW 121 is not coupled with the physical MB 1 which is the deployment location of FW 1, this combination is excluded from the object. In addition, at this time, the range of the sub physical NW may be expanded to be set as the deployment location candidate of the segment using the link of FIG. 7 in the range satisfying the performance requirement with respect to the segment. Further, the range of the sub physical NW or the range obtained by expanding the sub physical NW using the link is referred to as a segment deployment physical NW.

A combination of segment deployment physical NWs illustrated in FIG. 16(2) is created by performing this process.

In this manner, the deployment location of the logical network can be determined by establishing both of the performance requirement with respect to the segment and a plurality of performance requirements such as the performance requirement with respect to the logical MB not using a deployment location determination method for each performance requirement in the related art.

An unprocessed segment deployment physical NW is selected (S205).

Candidates of the logical MB and the abstracted physical port are calculated from mapping information of the performance requirement and the physical item candidate, the input logical MB, the performance requirement value to the abstracted physical port, and the resource availability (S206) illustrated in FIG. 4. For example, a performance requirement 20G of a LB 15A of FIG. 2 is “corresponding to 100 request/second,” and the candidates are narrowed down to the candidates 11 and 12 which can belong to the sub physical NW 11 by the physical server for virtual MB in which the realization type is “virtual” with reference to the realization type 5262 of FIG. 9 which is specified by the corresponding physical guideline 5213 from the fifth item with reference to FIG. 4. In addition, it is confirmed whether the resource is available with reference to the upper limit MB number 5263 and the deployed MB number 5264 which can be deployed in FIG. 9. Similarly, deployment location candidates of another logical MB or abstracted physical port are calculated. The candidates are narrowed down to the physical MB which can be used by the user ID as a requirement source, the physical server for virtual MB, and the physical port with reference to the available user ID 5277 of FIG. 10.

A combination of the abstracted physical port in an object segment deployment physical NW and the deployment location of the logical MB is calculated, and a path coupling the abstracted physical port with the deployment location is calculated, and then a constituent candidate in the segment deployment physical NW is calculated (S207). In a case where the sub physical NW has a multi-path configuration such as fabric, the path is passed through in a sub physical NW unit. Moreover, in a case where the sub physical NW does not have a multi-path configuration or the sub physical NW is changed into the segment deployment physical NW by the range of the sub physical NW being expanded by the link, the path is calculated using a Dijkstra method or the like.

A candidate of the abstracted physical port in the segment deployment physical NW and the deployment location of the logical MB illustrated in FIG. 16(3) is calculated by performing this process.

The configuration in the segment deployment physical NW is selected by the guideline specified by the user (S208). For example, when the user specifies the guideline as “a configuration with the lowest fee,” a total of the fee is calculated according to the deployment location of the resource having configurations in each of the segment deployment physical NW, and a configuration with the lowest fee is selected with reference to the fee 5258 in FIG. 8 and the fee 5266 in FIG. 9.

The guideline specified by another user is, for example, speed of the logical NW provision time.

Particularly, when there is no guideline specified by the user, a configuration with maximum distribution of resources such as an MB or a bandwidth being used in addition to the logical NW created until now is selected. In this manner, a broad range of configurations can be employed in the subsequent logical NW creation.

Further, proposed configurations may be presented to the user so as for the user to select a configuration therefrom.

In a case where there is an unprocessed segment, the process is returned to S205. When there is no unprocessed segment, the final configuration is selected from the combination of the segment deployment physical NWs by the guideline specified by the user (S210). The guideline specified by the user is calculated for each combination of the segment deployment physical NW in which the segment deployment physical NW whose internal structure is determined is calculated in S204, and the configuration corresponding to the process of the final logical NW is determined according to the result. The guideline specified by the user is a fee or the like in the same manner as that of S208, and a configuration with the maximum distribution of resources is selected in a case where there is no particular guideline specified by the user. Further, proposed configurations may be presented to the user so as for the user to select a configuration therefrom.

The deployment location to the process of the logical NW is determined illustrated in FIG. 16(4) by performing this process.

In this manner, it is possible to decrease the calculation amount by calculating the combination in the segment unit while the performance requirement to the logical MB is established and then by calculating the configuration in the segment deployment physical NW corresponding to the segment.

Although the present disclosure has been described with reference to example embodiments, those skilled in the art will recognize that various changes and modifications may be made in form and detail without departing from the spirit and scope of the claimed subject matter.

What is claimed is:

1. A method of constructing a logical network which is used when a logical network is constructed on a physical network by a management server in a network system in which the management server is coupled to the physical network to which a plurality of physical servers, or, a plurality of physical servers and a plurality of physical middleboxes are respectively coupled through a physical network apparatus,
wherein the logical network is a network to which a virtual machine, and any one or both of a physical middlebox and a virtual middlebox are coupled through any one or both of the physical network apparatus and a virtual network apparatus,
the virtual middlebox is realized on any one or both of the physical server and a physical middlebox apparatus, and
the method comprises:
causing the management server,
to receive configuration information of the logical network and a logical network reservation request including a performance requirement with respect to a constituent element of the logical network,
to determine the plurality of physical servers, or the plurality of physical servers and the physical middlebox, and the physical network apparatus which are deployment targets of the logical network, and setting contents therefor based on the received configuration information and the received performance requirement of the logical network, and
to determine the setting contents for the plurality of physical servers, or the plurality of physical servers and the physical middlebox, and the physical network apparatus which are all determined.

2. The method of constructing a logical network according to claim 1,
wherein the configuration information of the logical network includes information related to one or more logical switches which are constituent elements, and one or more logical middlebox apparatuses,
the logical switch is configured over a plurality of the physical network apparatuses, and includes setting items including a segment representing a broadcast domain in the logical switch, an abstracted physical port in association with the segment, and an abstracted logical port to which the logical middlebox apparatus is coupled, and
the performance requirement with respect to the logical network is specified by setting at least anyone of performance requirement specification objects including the logical switch, the segment in the logical switch, the abstracted physical port in association with the segment, the logical middlebox apparatus, and the abstracted logical port as an object.

3. The method of constructing a logical network according to claim 2, further comprising:
causing the management server,
to manage mapping information associating the kind of the performance requirement with a candidate of a physical item which becomes a deployment target for each kind of the performance requirement specification objects,
to set at least any one kind of the segment, the abstracted physical port, the abstracted logical port, and the middlebox apparatus as an object for specifying the performance requirement, and
to select the configuration of the deployment target of the logical network from the candidates of the physical items which become the deployment targets for each object for specifying the performance requirement.

4. The method of constructing a logical network according to claim 3, further comprising:
causing the management server,
to manage an attribute of the physical item used as the mapping information and as a guideline for performing selection from the candidates of the physical items in correspondence with the kind of the performance requirement,
to manage attribute information and network resource information of the middlebox apparatus,
to manage the attribute information and the network resource information of the physical port of the physical network apparatus coupling the physical server and the middlebox apparatus,
to manage the attribute information and the network resource information of a link between the physical network apparatuses,
to calculate the candidates of the physical network apparatuses which become the deployment targets according to the specified performance requirement for each segment,
to select a combination of the segment and a segment which can be coupled to a segment belonging to another by the segment and the middlebox apparatus belonging to the segment from among the calculated candidates,
to calculate the candidates of the physical middlebox apparatus, the physical server for the virtual middlebox apparatus, and the physical port of the deployment target according to the specified performance requirement related to the abstracted physical port belonging to the segment and the middlebox apparatus for each segment included in the combination selected by the segment,
to determine the deployment target in the segment according to the specified guideline from the combination of the segments, and
to determine the deployment target of the logical network according to the specified guideline from the combination of the segments.

5. The method of constructing a logical network according to claim 4,
wherein the mapping information includes a sub physical network which includes a plurality of the network apparatus as the physical item of the deployment target candidate of the segment in the logical switch, and
the method further comprises:
causing the management server,
to hold the attribute information and the network resource information for each sub physical network,
to calculate the sub physical network, or the sub physical network and a plurality of links with the physical network apparatus connected to the sub physical network as the deployment target candidate of the segment, and
to determine the deployment target of the logical middlebox apparatus and the abstracted physical port in the sub physical network unit.

6. The method of constructing a logical network according to claim 4, further comprising:
causing the management server,
to hold resource information related to the number of virtual middlebox apparatuses which can be accommodated in the physical middlebox apparatuses or the physical server, resource usage information at the present time, resource information related to a line bandwidth of a port and a link, and resource utilization situation information at the present time, and
to refer to resource availability calculated from the resource information of the deployment target candidate and the resource usage information when the deployment target candidate of the constituent element of the logical network is calculated.

7. The method of constructing a logical network according to claim 4, further comprising:
causing the management server,
to manage user information which is user list who can use the physical port, the middlebox apparatus, the sub physical network, and the link between physical network apparatuses, and
to refer to the user information which can be used when the deployment target candidate of the constituent element of the logical network is calculated and select the deployment target from among the middlebox apparatus which can be used for a user who requires construction of the logical network, the physical port, the link between network apparatuses, and the sub physical network.

8. The method of constructing a logical network according to claim 4,
wherein the mapping information related to the physical item candidate of the performance requirement includes exclusive unit information showing a range in which a plurality of constituent elements of the logical network in which the same kind of performance requirement is specified in the unit of the kind of the performance requirement are not deployed, and
the management server refers to the exclusive unit information and selects a configuration in which the plurality of constituent elements of the logical network in which the same kind of performance requirement is specified are not deployed in the exclusive unit from the deployment target candidates.

9. The method of constructing a logical network according to claim 3,
wherein the network system includes a virtual machine for a tenant constructed on the logical network and a virtual machine management server which creates a segment coupling the virtual machine, and
the method further comprises:
causing the management server,
to construct the logical network by setting the determined setting contents for the physical network apparatus in a target in which the logical network is deployed and for the middlebox apparatus, and
to acquire identification information of the segment to which the virtual machine is coupled from the virtual machine management server and perform setting for coupling the middlebox apparatus to the segment for the virtual switch and the physical network apparatus which accommodate the middlebox apparatus coupled to the segment.

10. The method of constructing a logical network according to claim 3, further comprising:
causing the management server,
to construct the logical network by setting the determined setting content for the physical network apparatus in a target in which the logical network is deployed and for the middlebox apparatus,
to acquire identification information of the segment to which the virtual machine is coupled from the virtual machine management server, and
to perform setting for realizing the required performance requirement for the physical port of the physical network apparatus corresponding to the abstracted physical port of the required logical switch, and the virtual switch and the physical network apparatus which accommodate the middlebox apparatus coupled to the segment.

11. A management server which is coupled to a physical network to which a plurality of physical servers, or, a plurality of physical servers and a plurality of physical middleboxes are respectively coupled through a physical network apparatus and constructs a logical network on the physical network,
wherein the logical network is a network to which a virtual machine, and any one or both of a physical middlebox and a virtual middlebox are coupled through any one or both of the physical network apparatus and a virtual network apparatus,
the virtual middlebox is realized on any one or both of the physical server and a physical middlebox apparatus, and
the method comprises:
causing the management server,
to receive configuration information of the logical network and a logical network reservation request including a performance requirement with respect to a constituent element of the logical network,
to determine the plurality of physical servers, or the plurality of physical servers and the physical middlebox, and the physical network apparatus which are deployment locations of the logical network, and setting contents therefor based on the received configuration information and the received performance requirement of the logical network, and
to determine the setting contents for the plurality of physical servers, or the plurality of physical servers and the physical middlebox, and the physical network apparatus which are all determined.

12. The management server according to claim 11,
wherein when the configuration information of the logical network related to one or more logical switches which are constituent elements and one or more logical middlebox apparatuses is received, and
the logical switch is configured over a plurality of the physical network apparatuses, and includes setting items including a segment representing a broadcast domain in the logical switch, an abstracted physical port in association with the segment, and an abstracted logical port to which the logical middlebox apparatus is coupled,
the performance requirement with respect to the logical network, which is to be specified setting at least any one of performance requirement specification objects including the logical switch, the segment in the logical switch, the abstracted physical port in association with the segment, the logical middlebox apparatus, and the abstracted logical port as an object is received.

13. The management server according to claim 12,
wherein mapping information associating the kind of the performance requirement with a candidate of a physical item which becomes a deployment location is managed for each kind of the performance requirement specification objects,
at least any one kind of the segment, the abstracted physical port, the abstracted logical port, and the middlebox apparatus is set as an object for specifying the performance requirement, and
the configuration of the deployment location of the logical network is selected from the candidates of the physical items which become the deployment locations for each object for specifying the performance requirement.

14. The management server according to claim 13,
wherein an attribute of the physical item used as the mapping information and as a guideline for performing selection from the candidates of the physical items in correspondence with the kind of the performance requirement is managed,
attribute information and network resource information of the middlebox apparatus are managed,
the attribute information and the network resource information of the physical port of the physical network apparatus coupling the physical server and the middlebox apparatus are managed,
the attribute information and the network resource information of a link between the physical network apparatuses are managed,
the candidates of the physical network apparatuses which become the deployment locations are calculated according to the specified performance requirement for each segment,
the segment and the middlebox apparatus belonging to the segment select a combination of the segment and a segment which can be coupled to a segment belonging to another from the calculated candidates,
the candidates of the physical middlebox apparatus, the physical server for the virtual middlebox apparatus, and the physical port of the deployment location are calculated according to the specified performance requirement related to the abstracted physical port belonging to the segment and the middlebox apparatus for each segment included in the combination selected by the segment,
the deployment location in the segment is selected according to the specified guideline from the combination of the segments, and
the deployment location of the logical network is determined according to the specified guideline from the combination of the segments.

15. The management server according to claim 14,
wherein a sub physical network which includes a plurality of the network apparatuses is included in the physical item of the deployment location candidate of the segment in the logical switch to be managed as the mapping information,
the attribute information and the network resource information for each sub physical network are held,
the sub physical network, or the sub physical network and a plurality of links with the physical network apparatus connected to the sub physical network are calculated as the deployment location candidate of the segment, and
the deployment location of the logical middlebox apparatus and the abstracted physical port is determined in the sub physical network unit.

16. The management server according to claim 14,
wherein resource information related to the number of virtual middlebox apparatuses which can be accommodated in the physical middlebox apparatuses or the physical server, resource usage information at the present time, resource information related to a line bandwidth of a port and a link, and resource utilization situation information at the present time are held, and
resource availability calculated from the resource information of the deployment target candidate and the resource usage information are referred to when the deployment target candidate of the constituent element of the logical network is calculated.

17. The management server according to claim 14,
wherein user information which is user list who can use the physical port, the middlebox apparatus, the sub physical network, and the link between physical network apparatuses is managed, and
the user information which can be used is referred to when the deployment location candidate of the constituent element of the logical network is calculated, and the deployment location is selected from among the middlebox apparatus which can be used for a user who requires construction of the logical network, the physical port, the link between network apparatuses, and the sub physical network.

18. The management server according to claim 14,
wherein exclusive unit information showing a range in which a plurality of constituent elements of the logical network in which the same kind of performance requirement is specified in the unit of the kind of the performance requirement are not deployed is included to be managed as the mapping information, and
the exclusive unit information is referred to and a configuration is selected in which the plurality of constituent elements of the logical network in which the same kind of performance requirement is specified are not deployed in the exclusive unit from the deployment location candidates.

19. The management server according to claim 13,
wherein when a virtual machine for a tenant constructed on the logical network and a virtual machine management server which creates a segment coupling the virtual machine are coupled to the physical network,
the logical network is constructed by setting the determined setting contents for the physical network apparatus in a location in which the logical network is deployed and for the middlebox apparatus, and
identification information of the segment to which the virtual machine is coupled is acquired from the virtual machine management server and setting for coupling the middlebox apparatus to the segment is performed for the virtual switch and the physical network apparatus which accommodate the middlebox apparatus coupled to the segment.

20. The management server according to claim 13,
wherein the logical network is constructed by setting the determined setting content for the physical network apparatus in a location in which the logical network is deployed and for the middlebox apparatus,
identification information of the segment to which the virtual machine is coupled is acquired from the virtual machine management server, and
setting for realizing the required performance requirement is performed for the physical port of the physical network apparatus corresponding to the abstracted physical port of the required logical switch, and the virtual switch and the physical network apparatus which accommodate the middlebox apparatus coupled to the segment.
